(19) United States
(12) Patent Application Publication
(10) Pub. No.: US 2012/0257278 A1
(43) Pub. Date: Oct. 11, 2012

(54) Optics with Simultaneous Variable Correction of Aberrations

(75) Inventors: Aleksey Nikolaevich Simonov, Delft (NL); Michiel Christiaan Rombach, Breda (NL)

(73) Assignee: AKKOLENS INTERNATIONAL B.V., Breda (NL)

(21) Appl. No.: 13/390,114

(22) PCT Filed: Aug. 16, 2010
(86) PCT No.: PCT/NL2010/050513

§ 371 Date: Jun. 25, 2012

(30) Foreign Application Priority Data
Aug. 14, 2009 (NL) 2003355

(51) Int. Cl. G02B 3/00; G02B 27/64

(52) U.S. Cl. 359/557; 359/754

(57) ABSTRACT

The invention refers to an optical system comprising at least two optical elements of which at least one is movable relative to the other in a direction perpendicular to the optical axis of the optical system, wherein the combination of optical elements is adapted to correct variable aberrations of at least two different orders simultaneously of which the degree of correction depends on the relative position of the optical elements. This optical system is adapted to correct aberrations which are variable and dependent on the position of the lens with respect to the subject/imaging plane. Further the optical system is adapted to correct aberrations varying along with defocus of the system. These aberrations may include second order aberrations, meaning defocus and astigmatism, third-order aberrations, meaning comas and trefoils, fourth-order aberrations, for example, spherical aberration, and further higher-order aberration terms.

Traditional imaging lenses and lens assemblies are used widely in various optical devices and systems, for example, photocameras, to project a final image on a photosensitive film or on an electronic image sensor. In the present document the terms and definitions regarding imaging/optical systems are adopted from J. W. Goodman, Introduction to Fourier Optics, McGraw-Hill Co., Inc., New York, 1996. Typical optical systems include multiple optical elements to correct various aberrations, mainly higher-order monochromatic Zernike terms, for example, spherical aberration, as well as chromatic aberrations. For example, monochromatic even-order aberrations can be traditionally corrected by additional refractive optical surface component, i.e. a component with a functional optical surface, according to

$$z = S ( x , y ) = \frac{{r}^{2}}{R \{ 1 + \sqrt{1 - ( 1 + k ) \times {( r / R )}^{2} \}}} + {a}_{1} {r}^{4} + {a}_{2} {r}^{6} + … + {a}_{n} {r}^{( 2 n + 2 )} ,$$

or more generally

$$z = S ( x , y ) = {\sum }_{n = 0}^{N} {C}_{n} {Z}_{n} ( x , y ) ,$$

where, r=\sqrt{x²+y²}; R is the radius of curvature; k is the conic parameter that specifies the type of conicoid (see, for example, D. Malacara and M. Malacara, Handbook of optical design, Marcel Dekker, Inc., New York, 2004); aₙ is the (2n+2)-th order polynomial coefficient, in most cases n≦2; Zₙ(x, y) is the n-th Zernike polynomial and Cₙ is the corresponding modal coefficient; N is the number of corrected modes. However, these corrections are of a fixed value and independent of the distance of lens to subject.

In practice, however, most aberrations are variable and dependent on the position of the lens with respect to the subject/imaging plane, meaning, for example, that the fixed correction becomes inefficient when the lens is focused at a different distance.

Consequently, the correction is inefficient at a range of focal distances because aberrations of optical systems generally vary along with focus of the system. These aberrations may include second order aberrations, for example, defocus and astigmatism, third-order aberrations, for example, comas and trefoils, fourth-order aberrations, for example, spherical aberration, and other higher-order aberration terms.

A relatively simple combination of optical elements in which the degree of correction of aberrations is coupled with the degree of focus is highly desirable. This document describes such simple optical systems for simultaneous correction of variable aberrations, for example, defocus aberration and any other aberration.

Wavefront encoding/decoding optical systems are described, for example, in US2005264886, WO9957599 and E. R. Dowski and W. T. Cathey (App. Opt. 34, 1859, 1995) and are widely used for extended depth of field (EDF) imaging. Simultaneous correction, or generation, of aberrations in such optical systems may be of interest for machine vision applications. Performance of the encoding optical mask for EDF can be adjusted, for example, depending on the range of EDF, or presence of additional aberrations, for example, spherical aberration. The present document describes variable phase filters which generate variable-amplitude higher-order aberrations along with a variable cubic term. Embodiments of such encoding optics are described by Dowski and co-workers, for example, in U.S. Pat. No. 5,748,371, 2004/145,808, 2003/169,944, EP 1,692,558, AU 2002219861 and WO 0,3021,333 which documents are incorporated herein by reference.

Fixed cubic phase filters are highly sensitive to wavelength of the light and therefore result in create image blur due to chromatic aberrations. Variable 3-rd order phase filters such as described in the present document adjust the amplitude of the 3-rd order term with respect to the wavelength which reduces said chromatic aberrations. One of the advantages of a variable cubic filter is the increased resolution for extended fields of view. This may result in a wide angle, high image quality and low chromatic aberration of the image acquired by the image sensor. Variable cubic phase filters and correction factors thereof of one 3-rd order element, two 4-th order elements and three 5-th order elements are described in this document.

Images projected by an image sensor can be encoded by fixed (one cubic phase filter) or variable cubic (or higher-order) phase filters, for example, by two forth-order optical elements or three fifth-order optical elements as set forth below. The numerical processing unit is an inverse digital decoding filter that generally recalculates the optical transfer function (OTF) of the whole optical system for different encoding parameters, for example, amplitudes of the cubic term etc., and calculates the resulting image using the corrected OTF. In particular, such a digital filter will restore the image produced by the cubic phase mask and produce an EDF image. The decoded final image has a significantly increased depth of field. For a general introduction to this approach refer to Dowski and Cathey (App. Opt. 34, 1859, 1995; App. Opt., 6080, 41, 2002) as well as expansion of these technologies in US-2004/228005 for variable phase masks. Variable correction of aberrations is desirable for these lenses for a wide range of technical applications.

All the optical systems and constructions described above can have optical surface components such that the combination of optical elements corrects variable aberrations of at least two different Zernike orders of which the degree of correction depends on the relative position of the optical elements. In principle, the invention is adapted to correct for aberrations of any order.

In case of an optical system with two optical elements, the formula which describes the shape of the optical surface component for variable correction of monochromatic aberrations expressed in terms of Zernike polynomials takes the form:

$$z = {S}_{Cp} ( x , y ) = {\int }_{ }^{x} {\sum }_{p = 0}^{∞} {C}_{p} {Z}_{p} ( {x}^{′} , y ) d {x}^{′} ,$$

where the integration sign denotes the indefinite integration over x′ and summation over p may include any number of terms, some of the weighting coefficients Cₚ may be zero. The formula which describes the shape of the optical components for variable correction of variable aberrations is

$$z = {S}_{Cp} ( x , y ) = {\int }_{ }^{x} d {x}^{″} {\int }_{ }^{{x}^{″}} {\sum }_{p = 0}^{∞} {C}_{p} {Z}_{p} ( {x}^{′} , y ) d {x}^{′}$$

in case of a lens construction with three optical elements, here the indefinite integration is performed over x′ and x″, and summation over p may include any number of terms, some of the weighting coefficients Cₚ may be zero. Both formulas allow for variable correction of variable aberrations. The order of aberration, i.e. number of Zernike modes, and degree of variable correction can be chosen by adjustment of the weight factors, i.e. aberration coefficients Cₚ, in the formulas.

Such optical systems, or assemblies of optical elements, can be designed to variably correct for aberrations of any order along with variable defocus for traditional imaging applications. Such optical systems can be also designed to variably correct for aberrations of any order along with a variable cubic amplitude for wave front coding/decoding imaging. Examples of and basic formulas for such lenses are given below.

Such additional variable aberration correcting optical surface components can be superimposed on, or be combined with, basic optical surface components of the lens which can be shaped according to

$$z = S ( x , y ) = \frac{A}{2} ( \frac{{x}^{3}}{3} + {xy}^{2} )$$

in a two-element variable focus lens for traditional imaging,

$$z = S ( x , y ) = \frac{A}{2} ( \frac{{x}^{3}}{3} + {xy}^{2} )$$

in a fixed optical element for wave front coding/decoding imaging,

$$z = {S}_{A} ( x , y ) = A ( {x}^{2} {y}^{2} + \frac{{x}^{4}}{6} )$$

in a three element traditional variable focusing lens,

$$z = {S}_{A} ( x , y ) = A ( {x}^{2} {y}^{2} + \frac{{x}^{4}}{6} )$$

in a two-quadric-element variable cubic phase filter for wave front coding/decoding imaging and, finally,

$$z = {S}_{C} ( x , y ) = C ( {x}^{2} {y}^{3} + \frac{{x}^{5}}{10} )$$

in three-quintic-element variable cubic phase filter for wave front coding/decoding imaging. In the formulas above, the coefficients A and C are chosen to comply with the requirements of the particular design of the optical system (for example, size, and the degree of the aberrations).

For example, a three-element quadric variable lens can have a first optical element shaped according to the formula z=S_{F}(x,y)=h₁+2F(ex²y²+fx⁴/6), a second optical element with a surface given by the formula: z=S_{N}(x,y)=h₂+N(gx²y²+hx⁴/6), and a third optical element with a optical surface component specified by the formula: z=S_{P}(x,y)=h₃−P(ix²y²+jx⁴/6). Here the coefficients k, F, e, f, h₂, N, g, h, h₃, P, i, j are chosen to comply with the requirements of the particular design of the optical system (for example, size, and the degree of the aberrations). This construction provides for a variable focusing lens. Using two elements only will result in a cubic phase filter with a variable cubic amplitude. A variable cubic phase filter with three quintic elements can be constructed accordingly. PCT/NL2006/05163 and the not yet published patent applications NL1,029,037/PCT2006/050113 and PCT/NL2006/05163 also describe these novel variable qadric and quintic lenses with three optical elements. This document will describe added terms to such lenses to correct variably for variable aberrations including but not restruicted to defocus aberration.

For example, two optical elements with parabolic optical surface components can be shifted perpendicular to the optical axis producing a variable tip/tilt. The magnitude of this tip/tilt changes linearly with the degree of shift. Optical surface components as described in this document can be designed such that they correct for this variable tip/tilt, producing a light beam propagating along the optical axis independent on the direction of the incident light. Such arrangement can be beneficial for, for example, solar concentrators, automotive applications (for example, aberration free focusing of headlights of cars), camera and binocular stabilization systems and other applications, including modern weapon systems and other defense and home-security applications. For example, by analogy, three optical elements with cubic surfaces can be designed such that perpendicular shift of two of these elements results in correction of variable tip/tilt.

Such correction of aberrations in combination with correction of variable tip/tilt is beneficial for modern camera and binocular stabilization systems, which are systems build into the optics, generally moving parabolic lenses which adjust for tip/tilt by moving a lens perpendicular to the optical axis. For small movements of such lenses the aberrations caused by shift itself might be negligible, but larger movements are likely to cause aberrations which will affect image quality. Addition of optical surface components to the moving optical elements can correct for such aberrations allowing a larger degree of image stabilization.

Technical and machine vision applications for simple lens systems with variable correction of aberrations along with focus/defocus are numerous, including various types of camera lenses, both for visible and infrared; variable focusing and aberration corrected lenses for (multi-layer) CD/DVD pick-up optics; objective lenses and additional lenses for microscopy systems and other lens types for machine vision applications. The specific application and requirements of such application dictates which construction and approach is selected for such specific application.

Applications of optics as solar concentrators for solar cells, being photovoltaic cells used for concentrating sunlight specifically, are centuries old, but concentrating light for generation of electricity is relatively novel. Traditionally tracking reflector/fixed receiver systems are used for solar concentration, for example a mirror which uses a fixed spherical reflector with a receiver which tracks the focus of light as the sun moves along its arc across the sky, employing generally a parabolic dish, to focus a large area of sunlight into a small beam or small spot. However, the reflector must follow the sun during the daylight hours by tracking along two axis, meaning have the form of a dual axis tracking reflector or ‘heliostat’. Such systems are mechanically complex, require maintenance and are expensive. The goal is to engineer a concentrating system that focuses sunlight, tracks the movement of the sun to keep the light on the small solar cell, and that can accommodate high heat caused by concentrating the power of the sun by 500 to 700 times—and is easy to manufacture. Devices resulting from of the inventions described in this document overcome the shortcomings of the prior art, meaning multiple axis tracking systems in obviating the need for tracking the sun over two axis but only one axis by a shifting one or two dimensional movement of optical elements.

Several embodiments, but not all, for the use of the inventions described in this document for solar concentration will be described below.

A, relatively flat, light concentrator for solar cells of which only at least one optical element shifts relatively to the optical axis should (a)—project a focal spot at only one fixed position or project the focal spot over a limited range and (b)—apply variable corrections to maintain a focal spot of minimum dimensions and of a precisely defined shape. Alternatively, a solar concentrator can have, for example, three cubic surfaces in an additive configuration, of at least one can shift perpendicular to the optical axis providing independent correction of tip/tilt in two (for example X and Y) directions. Such independent correction can be advantageous to follow the arcuate path of the sun.

Firstly, a basic embodiment of such concentrator has, for example, at least two optical elements of which at least one can shift perpendicular to the optical axis. At least two optical surface components can be distributed over these at least two optical elements, and optical surface components with different functions can be combined depending on the design of the concentrator. Such basic embodiment for a solar concentrator has, firstly, two parabolic optical surface components which, when at least one is shifted perpendicular to the optical axis, to adjust for tip/tilt of the light beam according to the angle of the sun. Secondly, at least two cubic optical surface components of which at least one shifts to allow variable defocus to position the focal spot at the correct position on the optical axis and, thirdly, at least two correcting optical surface components to variably correct for variable coma. Fourthly, additional correcting optical surface components will be likely needed to variably correct for other and for higher order aberrations. The amplitude and nature of aberrations is dependent on the overall design of the collector and generally less aberrations will occur when optical surface components are positioned close to each other favoring Fresnel, GRIN and light-grating optical designs Also, the nature of the focal spot depends on the type of the particular solar cell employed in the total solar construction.

Note that, for solar concentrator applications but also for all other applications the correcting optical surface components for variable tip/tilt and variable defocus can generally be calculated and simulated. However, corrective optical surface components for variable correction of coma and higher order aberrations can also be determined by, for example, multi-configuration ray-tracing iterative methods. These methods determine, by iteration, the shape of a surface most efficient for a specific function.

All the optical surface components mentioned above can also be added to reflective optical surface components, or to combinations of diffractive, refractive and reflective optical surface components.

Firstly, optical systems for technical and machine vision comprised of at least two optical elements of which at least one is movable relative to the other in a direction perpendicular to the optical axis which change focus of which the degree of change depends on the relative position of the optical elements are well know. Such lenses comprised of two cubic elements shaped according to

$$z = S ( x , y ) = \frac{A}{2} ( \frac{{x}^{3}}{3} + {xy}^{2} )$$

were first described by Louis Alvarez in U.S. Pat. No. 3,350,294, further developed for camera applications in for example U.S. Pat. Nos. 3,583,790 and 4,650,292 and recently for use as accommodating implantable intraocular lenses 1,025,622 and PCT/NL2006/05163. These documents are incorporated herein by reference.

Redesigning such lens according to

$$( \frac{{x}^{3}}{3} + {xy}^{2} ) + \int {\sum }_{q} {C}_{q} {Z}_{q} ( x , y ) d x$$

adds a variable correction of higher-order aberrations along with defocus in which the degree of correction depends on the weights of the coefficients C_{q} and their number, specified by the summation index q, chosen in the second term of the formula. Such a lens projects the final image on a light sensitive sensor or such a lens can project the phase-encoded intermediate image onto a light sensitive sensor for the subsequent reconstruction by digital decoding of the encoded image.

Secondly, lenses for technical and machine vision comprised of at least two optical elements of which at least one is movable relative to the other in a direction perpendicular to the optical axis which change focus of which the degree of change depends on the relative position of the optical elements can also be constructed of optical elements with optical surface components shaped according to quadric formulas

$$z = {S}_{A} ( x , y ) = A ( {x}^{2} {y}^{2} + \frac{{x}^{4}}{6} )$$

and quintic formulas

$$z = {S}_{C} ( x , y ) = C ( {x}^{2} {y}^{3} + \frac{{x}^{5}}{10} )$$

introduced above.

Redesigning such lenses according to

$$A ( {x}^{2} {y}^{2} + \frac{{x}^{4}}{6} ) + \int {\sum }_{q} {C}_{q} {Z}_{q} ( x , y ) d x or$$

$$A ( {x}^{2} {y}^{2} + \frac{{x}^{4}}{6} ) + {\int }^{x} d {x}^{″} {\int }^{{x}^{″}} {\sum }_{p} {C}_{p} {Z}_{p} ( {x}^{′} , y ) d {x}^{′}$$

and, alternatively,

$$( {x}^{2} {y}^{3} + \frac{{x}^{5}}{10} ) + \int {\sum }_{q} {C}_{q} {Z}_{q} ( x , y ) d x or \\ ( {x}^{2} {y}^{3} + \frac{{x}^{5}}{10} ) + {\int }^{x} d {x}^{″} {\int }^{{x}^{″}} {\sum }_{p} {C}_{p} {Z}_{p} ( {x}^{′} , y ) d {x}^{′}$$

provides variable correction of various orders of aberrations along with variable defocus or variable cubic amplitude according to the number of elements and constructions with several options for number of optical elements as outlined above. All the coefficients A, C, Cₚ in the formulas above have to be chosen as required by the particular application requirements.

The three-element optical system employing fifth-order refractive elements shaped according to:

$$z = {S}_{C} ( x , y ) = C ( {x}^{2} {y}^{3} + \frac{{x}^{5}}{10} )$$

provides a variable third-order cubic phase filter. Such construction can be applied as a variable cubic element for technical vision as a controllable phase filter for wave-front encoding/decoding in digital imaging systems. The signal received by an optical sensor, for example CCD or CMOS camera, can be subsequently decoded by digital post-processing and a final image with an extended depth of focus can be obtained. More generally, the expression for the sag function resulting in the same effect is given by: z=S_{C}(x, y)+f (y) x+g(y), where f(y) and g(y) are the arbitrary functions.

In the preferred embodiment the optical arrangement of a variable cubic phase filter includes a fixed element and two movable elements specified by the following sag functions: S₁=h₁−2S_{C}(x, y), S₂=h₂+S_{C}(x, y) and S₃=h₃+S_{C}(x, y), respectively. Constants h₁, h₂ and h₃ determine the central thickness of each refractive element. In this preferred embodiment, the amplitude of the resulting cubic term is Γ=2C(n−1)Δx². When the optical elements S₂ and S₃ are displaced by Δy in opposite directions along the Y-axis, then the system generates a phase difference of Ψ=6C(n−1)Δy²x²y which is mainly trefoil and coma with amplitudes of ∝C(n−1)Δy². In the described configuration of a variable cubic phase filter the two shifting optical elements (S₂ and S₃) are in an “additive” configuration, whereas the third fixed element (S₁) in a “subtractive” configuration. It should be noted that the dependence of Γ on Δx remains the same for the sag function z=S_{A}(x, y)+f(y) x+g(y), where f(y) and g(y) are the arbitrary functions of y. These functions can be modified to optimize the shape of the three-element system.

Also, a variable fifth-order cubic filter described in this patent can be applied as a variable phase mask for wave encoding/decoding imaging systems. US-2004/228005 mentions such variable phase masks in general terms and does not cover the variable correction of aberrations of such phase masks. From US-2004/228005, in combination with U.S. Pat. No. 3,583,790, a man skilled in the arts would conclude that such phase masks can be optimized, meaning corrected for aberrations for a fixed value of α. However, corrections for aberrations for an extended range of values for α can be achieved by applying the principles of variable correction of aberrations as set forth in this patent. This will improve the resolution, contrast and insensitivity to chromatic aberrations of the image for variable extended depth of field situations.

The properties of a variable fifth-order filter can be calculated or, alternatively, a combination of fifth-order additional optical surface components can be determined providing controllable decoding (by generating third-order aberration terms) of images antecedent to their digital processing. The forth-order aberrations, for example spherical aberration, and higher-order aberrations induced by the variable phase mask can thus be predicted and the mask which corrects these aberrations for the whole imaging system can be designed.

For practical purposes single-element and multiple-element wave-front coding lenses as preferred embodiment should be designed to correct for spherical and chromatic aberration. A preferred embodiment of lens described above includes two optical elements of which at least one is movable relative to the other in a direction perpendicular to the optical axis and at least one optical element has a refractive surface shaped according to

$$z = S ( x , y ) = \frac{A}{2} ( \frac{{x}^{3}}{3} + {xy}^{2} ) + \frac{B}{2} \sqrt{5} \{ x - 2 {x}^{3} - 6 {y}^{2} x + \frac{6}{5} {x}^{5} + 4 {y}^{2} {x}^{3} + 6 {y}^{4} x \} .$$

Such a lens is well suited for variable correction of, in this example mainly spherical, aberration along with variable defocus. Such lenses with a variable correction of spherical aberration in which the degree of correction is coupled to the degree of defocus can be applied, for example, in optical pick-up systems for multi-layer CD and DVD discs which refocus on spatially separated layers. A fixed correction of aberrations according to traditional principles set forth above induces an increased level of spherical aberration with refocusing at layers located at different distances from the lens which hampers correct reading of pit-signals. Variable correction of spherical aberration along with variable focus in traditional imaging or alternatively, in a variable cubic amplitude in wave front coding/decoding imaging will enhance accurate reading of different disc layers.

The two elements of such lens can be fused to form a single fixed optical element for these applications in combination with digital post-processing of the image. The single fixed cubic elements can be used for digital imaging in which a single cubic element projects an intermediate image onto a light sensitive sensor. The intermediate image, in turn, can be reconstructed into a final image with an extended depth of field by digital post-processing. Such technology is well documented and an example is given by AU 2002/2,219,861. This document is included in this patent by reference. This technology is also referred to as wave front coding/decoding imaging. Redesigning such single lens element lens according to

$$( \frac{{x}^{3}}{3} + {xy}^{2} ) + \int {\sum }_{q} {C}_{q} {Z}_{q} ( x , y ) d x$$

adds a variable correction of various orders of aberrations, second term, along with defocus, first term, in which the degree of correction depending on the weights of the factors chosen in the second term of the formula at a digital post-processing stage. Such single lens element can also be constructed by two elements which do not move and such elements can be joined into a single element. Such cubic phase mask has a delay function of P(x,y)=exp(jα(x³+y³)), in which α is a parameter which determines the degree of increase in depth of focus. The resolution of such a system can be optimized, meaning boosting of higher frequencies with the attendant higher contrast at the expense of noise. For this optimization we describe optics to vary the MTF of the imagining system by varying properties of the phase mask while keeping parameters of the detector, for example pixel size and others, as constants. The aberrations of various orders can be simultaneously corrected by a single cubic phase mask utilizing the principles for such correction as described in this patent.

For example, such a single element can take the form of

$$z = S ( x , y ) = \frac{A}{2} ( \frac{{x}^{3}}{3} + {xy}^{2} ) + \frac{B}{2} \sqrt{5} \{ x - 2 {x}^{3} - 6 {y}^{2} x + \frac{6}{5} {x}^{5} + 4 {y}^{2} {x}^{3} + 6 {y}^{4} x \}$$

The term “optical surface” as used throughout the text and claims refers to the shape of an actual surface but also includes its “optical properties” or produced “optical effects” in addition to a traditional description of an optical surface. Usually the lens surface is assumed to be a smooth and homogeneous surface shaped according to the model function, but with current technologies similar optical properties can be achieved by using, for example, gradient index (GRIN) optical elements or various Fresnel elements (or diffraction optical elements—DOEs) which can be physically flat. Other optical technologies to achieve the optical properties, as implied by the optical models described in this patent, are considered to be part of this patent.

All embodiments described in this document can have refractive designs, such as lenses which can be of the traditional type but also have GRIN and also Fresnel designs in addition to a traditional lens designs, as well as equivalent reflective designs, for example free-form mirrors. GRIN and Fresnel designs allow lenses to be manufactured significantly thinner compared to traditional lenses and the degree of chromatic aberrations can be reduced by Fresnel designs and GRIN designs offer alternatives with regard to distribution of optical quality over the surface of the optics.

All optics described in this document are in the category “free form optical surface components”. Until recently such optical surface components were difficult if not impossible to manufacture. Now free form optical surface components described in this patent can be manufactured by precision lathing technology as already shown for similar optical surface components for medical applications in U.S. Pat. Nos. 1,025,622, 1,029,041 and “Varifocal optics for a novel accommodating intraocular lens” (Proc. Of SPIE Volume: 6113, MEMS/MOEMS Components and their applications II, 2006) and “Cubic optical elements for an accommodative intraocular lens” (Optics Express Vol. 14 (17), pp. 7757-7775, 2006). However, other manufacturing technologies such as sol gel manufacturing, molding and others can likely be applied.

Maintaining moving optical parts in parallel planes is important for the overall optical quality of the multiple-element lens described in this text. Sandwiching a layer of an elastic polymer between, or partly between, the optical elements will aid maintenance of the plane parallelism. For technical applications, as set forth above, a layer of an elastic polymer can be positioned between two inelastic polymer or glass or other part made of a transparent material and attached to said inelastic layers. The inelastic layers carry the optical surface components on the outside only, the inside only, or the optical surface components can be distributed over the inside and outside. This construction will ensure proper parallel alignment of the optical surface components and allow the desired lateral shifting movement of the inelastic polymer layers. A simple actuator can be part of the assembly to shift the optical elements. A three element lens can be constructed likewise with two layers of elastic polymer between the three inelastic optical elements.

As described above we have designed lenses which variably correct for at least two aberration terms of a different Zernike order which can be applied as variable lenses for technical and machine vision and which can be designed to variably correct for defocus or can be designed to variably correct for cubic phase delay.

A static single-element phase filter allows for a relatively simple construction. Such element can be assembled directly on top of a sensor, being a photodiode or an array of photodiodes. Also, additional single elements can be added to allow for sensing of multiple signals, for example signals originating from lasers of different wavelengths. Decoding software can be embedded in an electronic chip in combination with phase filters and sensors. The software can likely be programmed as to recalculate the MTF of the optical system while minimizing the influence of the residual term

$$R ( x , y , Δ x ) = {\sum }_{p = 1} \frac{Δ {x}^{2 p + 1}}{( 2 p + 1 ) !} {\sum }_{q} {C}_{q} \frac{{\partial }^{( 2 p + 1 )} {Z}_{q} ( x , y )}{\partial {x}^{( 2 p + 1 )}} .$$

Optimization of the digital restoration procedure of encoded information generated by the lens systems, set forth above, will be the topic of additional patent applications.

With regard to solar concentrators for solar cells, the optics, or, alternatively, array of optics are fixed at a tip/tilt in accordance with the latitude of the site, but not necessarily so. Note that, without said movement the daily arc of the sun across the face of the optics will produces an arcuate path of the focal spot which shape of the path depends on the specific design of the optics. However, besides such movement along a path, such focal spot will be an imperfect spot due to aberrations, for example accompanying variable coma, induced by varying angles of the sun's rays entry into the optical system when the optical system is not an, albeit highly impractical, free-hanging ideal perfect spherical lens.

In designs for solar concentrators including inventions described in this document the focal spot remains near perfect independent of the angle of entry of the sun's rays into the optical system with a minimum of mechanical movement. Such mechanical movement is two dimensional, or flat, and over at least one of the two axis.

In a first and most simple embodiment for a solar concentrator the concentrator is tip/tilted at an angle according to latitude and two parabolic lenses, henceforth ‘paraboles’ move independently from each other along one axis. Driven by at least one standard linear actuator, of a piezo or other type, at least one of the paraboles shifts relatively to the other along a path which is such that the focal spot resulting from the lens function resulting from the paraboles remains fixed, meaning at the point where the solar cell is positioned. Clearly, such design invariably results in a number of undesirable variable higher order aberrations, in this example mainly variable comas, which shapes vary according to the positioning of the paraboles with regard to the sun. Such aberrations will distort the shape of the focal spot leading to inefficiencies of the construction in converting sunlight into electrical energy. Said variable aberrations can be corrected for by additional optical surface components, in principle anywhere on the optical elements, but preferably on top of the paraboles, with a shape which can be derived from the optical principles described in this document.

Additionally the solar cell can be fitted with an array of for example photodiodes along its rim to allow for a self-centering system for the focal spot, meaning the at least one actuator is driven by such self correcting loop to maintain the focal spot precisely centred on the solar cell. Energy for the at least one actuator and accompanying electronics can be derived from the solar cell construction resulting in a completely independent solar unit.

Arrays of a multitude of small lenses (‘lenslets’) are likely more practical and cost efficient. Such arrays of lenses are well-known, for example as optics for Shack-Hartmann sensors and easy to manufacture by for example CD-embossing technologies. Clearly, prism functions have to be added to the individual lenslets to result in a single focal spot, and each lenslet must have individual optical surface components correcting for said variable aberrations. Clearly, such arrays can be combined in an even larger array of said arrays, with at least one array performing the positioning function for the total construction. The shape of the lenslets can eviate from a half-sphere, the shape not necessarily the same for all lenslets and the degree of correction of variable aberrations and other specifics depends on the specifications of the solar cell, specifications for the complete construction and economic considerations.

Image stabilization optics, in combination with optical surface components described herein will allow for compensation of larger movements with increased optical quality compared to existing methods. Traditionally a floating lens element is moved orthogonally to the optical axis of the lens using electromagnets. Vibration is detected using two piezoelectric angular velocity sensors to detect horizontal movement and vertical movement. Recent lenses offer an ‘Active Mode’ that is intended to be used when shooting from a moving vehicle and should correct for larger shakes. Such systems can benefit from variable corrections of aberrations as set forth in this document.

Other applications described herein can be in automotive components (for example focusing of headlights), defense, medical apparatus at others.

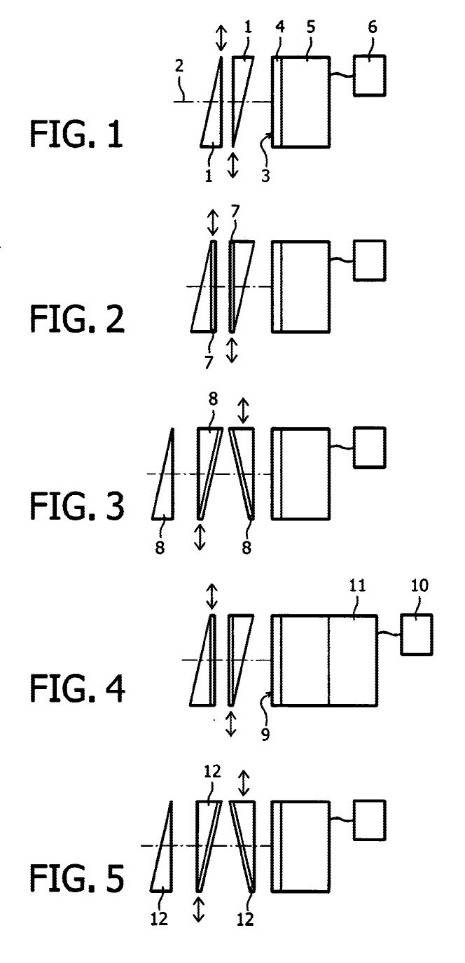

FIG. 1. Basic traditional variable-focus lens—starting point of inventions described in this document, namely, two cubic optical elements, 1, forming a varifocal lens and which can shift perpendicular to the optical axis, 2, focusing an image, 3, on a light sensitive sensor, 4, which image is processed by an electronic apparatus, 5, to be shown on for example a computer screen, 6. For all figures: Note that in all Figures the complex shapes of free form optical elements and correcting optical surface components thereon have been schematically reduced to triangles.

FIG. 2. Basic traditional variable focus lens with variable correction of aberrations. As in FIG. 1—optical surface components for variable correction of aberrations, 7, have been added, in this example on the inside of the optical construction.

FIG. 3. Varifocal lens with variable correction of higher-order aberrations. As FIG. 2—three-elements are employed with fourth-order optics, 8.

FIG. 4. Variable cubic phase filter with variable correction of higher-order aberrations. As FIG. 3—with two fourth-order optical elements which produce a cubic wave front for an intermediate image, 9, which is reconstructed in a final image, 10, by a decoding processor, 11.

FIG. 5. Variable focus lens with variable correction of higher-order aberrations. In this example, the lens includes three fifth-order optical elements, 12.

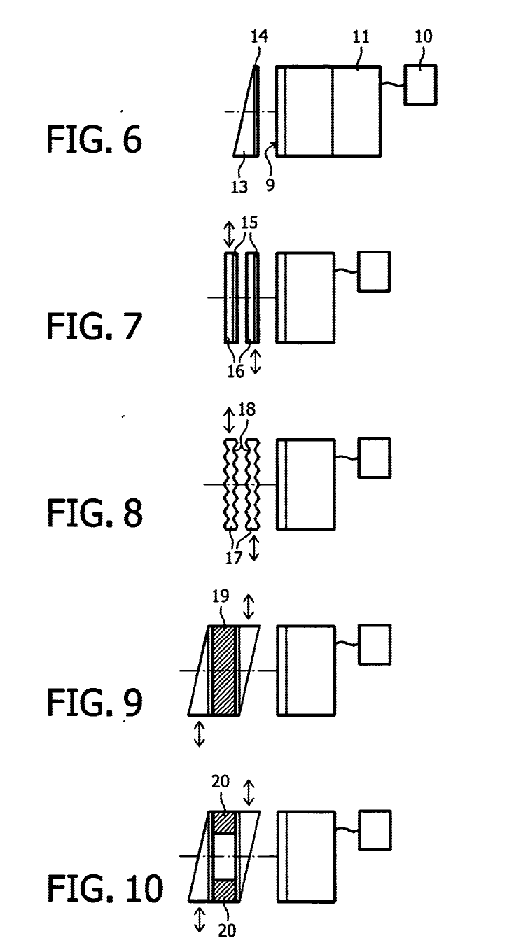

FIG. 6. Fixed cubic phase filter, 13, with, in this example, one correction surface, 14, for variable aberrations.

FIG. 7. As FIG. 2—with optics, 15, as flat GRIN designs, with, in this example, the correcting optical surface components, 16, positioned on the outside of the construction.

FIG. 8. As FIG. 2—with optics, 17, as Fresnel design with, in this example, the correcting optical surface components, 18, positioned on the inside of the construction.

FIG. 9. As FIG. 2—with optical element connected by elastic polymer layer, 19.

FIG. 10. As FIG. 9—with optical elements connected, in part, by elastic polymer layer, 20.

### TECHNICAL INFORMATION

We now proceed to further derive formulas and explain the main invention which enables design of lenses in more detail as set forth above. In the case of complementary configuration variable third- and higher-order aberrations, expressed in terms of Zernike polynomials, as well as their linear combinations are generated and all change linearly with the lateral shift Δx. The following base sag function S(x, y) is used:

$$z = S ( x , y ) = P \int {\sum }_{q} {C}_{q} {Z}_{q} ( x , y ) d x ,$$

where P is the constant. The base function can be added to, for this example, a lens with two cubic elements:

$$z = S ( x , y ) = \frac{A}{2} ( \frac{{x}^{3}}{3} + {xy}^{2} ) + \frac{1}{2} \int {\sum }_{q} {C}_{q} {Z}_{q} ( x , y ) d x ,$$

where C_{q} is the modal coefficient corresponding to the q-th Zernike aberration term. Assuming that the elements are made of a material with a refractive index n, the optical path L in the two-element complementary geometry described above, is given by:

L=nh₁+nS(x−Δx,y)+h₀+nh₂−nS(x+Δx,y).

In this formula the constants h₁, h₂ determine the central thickness of each refractive element, and h₀ is the central distance between the respective elements. After simplification, the equation for L yields:

$$L = ( {nh}_{1} + {h}_{0} + {nh}_{2} ) - An Δ x {\sum }_{q} {C}_{q} {Z}_{q} ( x , y ) + nR ( x , y , Δ x ) ,$$

and the corresponding optical path difference (OPD) becomes:

$$OPD = ( n - 1 ) ( {h}_{1} + {h}_{2} ) - A ( n - 1 ) ( {y}^{2} + {z}^{2} ) Δ x - ( n - 1 ) Δ x {\sum }_{q} {C}_{q} {Z}_{q} ( x , y ) + ( n - 1 ) R ( x , y , Δ x )$$

So, as it seen from the derived expression, when the optical parts of the two-element system move laterally by Δx each, the system produces:
1. First term, (n−1)(h₁+h₂))—defines a constant piston;
2. Second term, (n−1)ΔxA)—defines the varifocal parabolic lens. The focal distance of the lens is F=[2A(n−1)Δx]⁻¹;
3. Third term,

$$( n - 1 ) Δ x {\sum }_{q} {C}_{q} {Z}_{q} ( x , y ) )$$

—represents all aberration terms including defocus or linear combination of terms whose amplitudes linearly vary with Δx, i.e. new amplitudes of aberrations which correspond to (n−1)ΔxC_{q}. Additional optical power produced by the defocus term C₄ is: F⁻¹=2\sqrt{3}C₄(n−1)Δx, which is expressed in diopters.
4. Forth and last term, (n−1)R(x, y, Δx))—a contribution of higher-order shift-dependent terms Δx³, Δx⁵, ect. When Δx<<1, these terms are negligibly small and can be omitted for practical purposes.

So, a pair of refractive elements, shaped according the base function S(x, y) given above, provides linear change of the specified optical aberrations along with defocus.

Analogously, the inclusion of additional optical surface components for variable control of various aberrations in such three-element lenses can be achieved according to the design principles set out above. So, f(y) and g(y) are the arbitrary functions of y. These functions can be used to optimize the shape of the three-element system. Assuming that the optical elements are made of a material with a refractive index n, the optical path L in the above described geometry for the fourth-order varifocal lens becomes:

L=nh₁+nS_{C}(x−Δx,y)+h₀₁+nh₂+nS_{C}(x+Δx,y)+h₀₂+nh₃−2S_{C}(x,y),

Constants h₁, h₂, h₃ determine the central thickness of each refractive element, and h₀₁, h₀₂ are the central distances between them. After simplification, the expression for optical path difference (OPD) can be rewritten as:

OPD=(n−1)(h₁+h₂+h₃)+2C(n−1)(y³+z³)Δx²+C(n−1)xΔx⁴,

where the first term (n−1)(h₁+h₂+h₃) is the constant, the second term 2C(n−1)(y³+z³)Δx² is the variable cubic contribution and the third term C(n−1)xΔx is a tip/tilt factor that changes as Δx⁴. The amplitude is quadratically-dependent on the lateral shift Δx of optical elements with respect to the optical Z-axis.

A main document is this regard is U.S. Pat. No. 3,583,790 which describes only one particular case of spherical aberration which is corrected using specific “quintic” optical surface components. U.S. Pat. No. 3,583,790 describes two cubic refracting plates for variable focal power according to U.S. Pat. No. 3,350,294 and thus described

$$z = S ( x , y ) = \frac{A}{2} ( \frac{{x}^{3}}{3} + {xy}^{2} )$$

to which is added a correction for spherical aberration. The term for spherical aberration contains a non-zero 5th order term following

$$x = ay + {cy}^{3} + 3 {cyz}^{2} + {gy}^{5} + \frac{10}{3} {gy}^{3} {z}^{2} + 5 {gyz}^{4} \qquad ( 1 )$$

For brevity, Eq. 1 can be rewritten: x=S (y, z), where x, y, z are the Cartesian coordinates.

When we investigate this particular solution to spherical aberration in more detail we conclude the following. Assuming that the refractive elements are shifted by Δy, optical path L of the ray intersecting the first element at {y, z} is:

L=nh₁+nS(y−Δy,z)+h₀+nh₂−nS(y+Δy,z) (2),

where n is the refractive index of the plates material; h₁ and h₂ are the central thicknesses of the refractive plates; h₀ is the central distance between them, and S refers to Eq. 1.

Retaining only linear in Δy terms, Eq. 2 yields:

L=(nh₁+h₀+nh₂)−2anΔy−6cn[y²+z²]Δy−10gn{y²+z²}²Δy (3).

In terms of optical path difference (OPD), OPD of the ray due to reciprocal Δy shift of plates results in:

OPD=(n−1)(h₁+h₂)−2a(n−1)Δy−6c(n−1)[y²+z²]Δy−10g(n−1){y²+z²}²Δy (4).

From Eq. 4, it is concluded that the invented element produces (when its parts each move laterally by Δy):
1. First term ((n−1)(k+h₂))—a constant factor;
2. Second term (2a(n−1)Δy): a linear piston phase shift with no likely application for optical systems except for phase sensitive devices such as interferometers;
3. Third term (6c(n−1)[y²+z²]Δy): a parabolic lens with variable power. The focal distance of the lens is in this embodiment F=[12c(n−1)Δy]⁻¹ and coincides with A=3c according to U.S. Pat. No. 3,305,294;
4. Fourth term (10 g(n−1){y²+z²}²Δy: a fifth order term. This term produces third-order spherical aberration linearly changing with Δy. The amplitude of spherical aberration is: W₄₀=10 g(n−1)Δ/λ with λ, the wavelength of light.

It can be concluded that the parabolic and quadric terms in Eq. 4 vary linearly with Δy. Thus, the amplitudes of defocus and spherical aberration are intrinsically interrelated. So, the optical element using a tandem pair of the quintic phase plates as specified by Eq. 1 is a narrow subclass of two-element varifocal Alvarez lenses as described in U.S. Pat. No. 3,350,294 and this optical system is a varifocal lens which additionally generates a spherical aberration that changes linearly with Δy. Such an optical element has a very specific range of applications where defocus and spherical aberration should be changed simultaneously.

In this document a variable correction of a given aberration or simultaneous correction of many aberrations with predetermined weights is described. The magnitudes of aberrations vary with the lateral shift Δx and their relative weights can be adjusted as required. An example for variable correction of spherical aberration is provided below.

Reciprocal shift of the two refractive elements with the profile S(x, y) specified above by Δx in the opposite direction perpendicular to the optical axis results in the linear change of the q-th Zernike aberration term (excluding defocus, i.e. q≠4). The new modal amplitudes C′_{q} become C′_{q}=(n−1)ΔxC_{q},

Reciprocal shift of the two refractive elements with the profile S(x, y) specified above by Δx in the opposite direction perpendicular to the optical axis results in the linear change of the combination of Zernike aberration terms

$${\sum }_{q} {C}_{q}^{′} {Z}_{q} ( x , y ) ,$$

where the new modal amplitudes, according to Claim 4c, are C′_{q}=(n−1)ΔxC_{q}. The relative weights of monochromatic aberrations can be adjusted as required by choosing the corresponding coefficients C_{q}.

As an example, simultaneous correction of defocus and spherical aberration in a two-element variable lens could be accomplished as follows. Retaining defocus and spherical aberration terms only, the above specified sag function S(x, y) takes the form:

$$\begin{matrix}z = S ( x , y ) \\ = \frac{A}{2} ( \frac{{x}^{3}}{3} + {xy}^{2} ) + \frac{B}{2} \int {Z}_{12} ( x , y ) d x = \\ = \frac{A}{2} ( \frac{{x}^{3}}{3} + {xy}^{2} ) + \frac{B}{2} \sqrt{5} \{ x - 2 {x}^{3} - 6 {y}^{2} x + \frac{6}{5} {x}^{5} + 4 {y}^{2} {x}^{3} + 6 {y}^{4} x \} ,\end{matrix}$$

where B is the coefficient of spherical aberration Z₁₂. The optical path difference becomes

OPD=(n−1)(h₁+h₂)−A(n−1)(y²+z²)Δx−B(n−1)ΔxZ₁₂(x,y)+(n−1)R(x,y,Δx),

where the residual shift-dependent term R is given by

R(x,y,Δx)=−{A/3+4B\sqrt{5}y²−2B\sqrt{5}+12B\sqrt{5}x²}Δx³−6B\sqrt{5}Δx⁵/5.

Here, the first part is a combination of defocus (Z₄) and astigmatism (Z₅) with amplitudes 4B\sqrt{5}Δx³ and −4B\sqrt{5}Δx³, respectively; the last term is a piston.

Similarly, a three-element system employing quadric optical elements according to the formula

$$z = S ( x , y ) = A ( {x}^{2} {y}^{2} + \frac{{x}^{4}}{6} ) + B \int d x \int {Z}_{12} ( x , y ) d x$$

can be constructed to provide variable focusing power along with variable spherical aberration.

For a three-element system, additional optical surface components providing variable correction of higher-order aberrations as well as their linear combinations can be implemented for such a cubic element using the following basic sag function, replacing S_{C}(x, y) by the S_{C}_{ₙ}(x, y) in the formulae above:

$$z = {S}_{Cp} ( x , y ) = {C}_{0} ( {x}^{2} {y}^{3} + \frac{{x}^{5}}{10} ) + {\int }^{x} d x {\int }^{x} {\sum }_{p} {C}_{p} {Z}_{p} ( {x}^{′} , y ) d {x}^{′} ,$$

where Cₚ is the modal coefficient corresponding to the p-th aberration term in Zernike representation. Assuming that the optical elements are made of a material with a refractive index n, the optical path in the above described geometry can be rewritten:

L=nh₁+nS_{C}_{ₚ}(x−Δx,y)+h₀₁+nh₂+nS_{C}_{ₚ}(x+Δx,y)+h₀₂+nh₃−2S_{C}_{ₚ}(x,y),

Constants h₁, h₂, h₃ determine the central thickness of each refractive element, and h₀₁, h₀₂ are the central distances between them. After simplification, the equation for optical path difference (OPD) becomes:

$$O P D = ( n - 1 ) ( {h}_{1} + {h}_{2} + {h}_{3} ) + 2 {C}_{0} ( n - 1 ) ( {y}^{3} + {z}^{3} ) Δ {x}^{2} + ( n - 1 ) Δ {x}^{2} {\sum }_{p} {C}_{p} {Z}_{p} ( x , y ) + ( n - 1 ) {R}^{′}$$

where the first term is the constant, the second term generates variable cubic contribution whose amplitude changes as 2C₀(n−1)Δx², the third term is a linear combination of Zernike polynomials with variable amplitudes Cₚ(n−1)Δx², and R′ is the residual term comprising even-order in Δx² contributions:

$${R}^{′} = 2 {\sum }_{q = 2}^{ } \frac{Δ {x}^{2 q}}{( 2 q ) !} {\sum }_{p} {C}_{p} \frac{{\partial }^{( 2 q )} {Z}_{p} ( x , y )}{\partial {x}^{( 2 q )}} .$$

Note that for small shifts Δx<<1, the residual term R′˜O(Δx⁴) becomes negligibly small and can be ignored for the majority of practical purposes.

In compliance with the general formula given above, the higher-order aberrations and their linear combinations with any specified weights can thus be generated to correct optical aberrations in a variable manner. The aberration amplitudes of the produced contributions changes in accordance with dx². Such an optical system can be implemented to improve the overall resolution of an encoded image with an extended depth of field.

Reciprocal shift of the two refractive elements with the profile S(x,y) specified above by Δx in the opposite direction perpendicular to the optical axis, aside from the monochromatic aberrations Z_{q}, expressed in terms of Zernike polynomials, linearly changing with Δx, produces the nonlinearly varying residual term R:

$$R ( x , y , Δ x ) = {\sum }_{p = 1} \frac{Δ {x}^{2 p + 1}}{( 2 p + 1 ) !} {\sum }_{q} {C}_{q} \frac{{\partial }^{( 2 p + 1 )} {Z}_{q} ( x , y )}{\partial {x}^{( 2 p + 1 )}} .$$

Note that R=0 for the second order aberrations (meaning defocus, Z₄, and various astigmatisms, Z₃, Z₅) and R≠0 for higher-order aberrations. In most cases, the lateral shift is small with respect to the system aperture (that is supposed to be unity in the formulae above), so Δx<<1 and the residual term R˜O(Δx³) becomes negligibly small.

It should be noted that a disadvantage of the reported designs and optical principles is that, in simultaneous correction of many aberrations or correction of an aberration with an order higher then two, for example trefoils, comas and spherical aberrations etc., using a two-element system the following base function in, for example, a two optical element lens:

$$z = S ( x , y ) = \frac{A}{2} ( \frac{{x}^{3}}{3} + {xy}^{2} ) + \frac{1}{2} \int {\sum }_{q} {C}_{q} {Z}_{q} ( x , y ) d x ,$$

the contribution of the residual term nonlinearly increases with Δx as given by:

$$R ( x , y , Δ x ) = {\sum }_{p = 1} \frac{Δ {x}^{2 p + 1}}{( 2 p + 1 ) !} {\sum }_{q} {C}_{q} \frac{{\partial }^{( 2 p + 1 )} {Z}_{q} ( x , y )}{\partial {x}^{( 2 p + 1 )}} ,$$

according to which formula the limitations of correction can be determined in relation to degradation of the resulting lens parabolic optics. Whether these limitations have been reached is dependent on the application and requirements on the variable lens with variable correction of aberrations.

Optics described in this document can be of a refractive, diffractive or reflective (mirrors) nature, or combinations thereof, and be arranged in arrays of lenses (lenslets). Movement of optical elements perpendicular to the optical axis can be parallel shift but also rotation around an axis which axis can be positioned within the diameter of the optical elements (for example rotation around a central axis) but also be positioned outside the diameter of the optical elements.

Applications of optics described in this document include, but are not restricted to imaging, including human vision (for example spectacles) and machine vision (for example various types of cameras), including variable phase masks (for example cubic phase masks) for wave front encoding/decoding imaging, solar concentrators, image stabilization systems, including active stabilization systems (image stabilization optics, also called vibration reduction/compensation, shake reduction, in combination with optical surface components described herein will allow for compensation of larger movements with increased optical quality compared to existing methods) and CD/DVD pick-up systems, like multilayer pick-up systems for rapid aberration free focusing on selected layers and weapon targeting systems.

1. An optical system comprising at least two optical elements of which at least one is movable relative to the other in a direction perpendicular to the optical axis of the optical system, characterized in that the combination of optical elements is adapted to correct variable aberrations of at least two different orders simultaneously of which the degree of correction depends on the relative position of the optical elements.

2. The optical system according to claim 1 characterized in that at least two optical surfaces of the optical elements have an optical surface component according to
$$z = {S}_{Cp} ( x , y ) = {\int }^{x} {{\sum }_{p = 0}}^{∞} {C}_{p} {Z}_{p} ( {x}^{′} , y ) d {x}^{′} .$$

3. The optical system according to claim 1 characterized in that at least three optical surfaces of the optical elements have an optical surface component according to
$$z = {S}_{Cp} ( x , y ) = {\int }^{x} d {x}^{″} {\int }^{{x}^{″}} {{\sum }_{p = 0}}^{∞} {C}_{p} {Z}_{p} ( {x}^{′} , y ) d {x}^{′} ,$$

4. The optical system according to claim 1 including at least two optical surface components for variable correction of defocus aberration characterized in that it has at least two additional optical surface components for simultaneous variable correction of at least one other optical aberration.

5. The optical system according to claim 4 with at least two optical surface components according to
$$z = S ( x , y ) = \frac{A}{2} ( \frac{{x}^{3}}{3} + {xy}^{2} )$$
for variable correction of defocus aberration characterized in that it has at least two additional optical surface components for simultaneous variable correction of at least one other optical aberration.

6. The optical system according to claim 1 including at least two optical surface components for variable correction of tip/tilt aberration characterized in that it has at least two additional optical surface components for simultaneous variable correction of at least one other optical aberration.

7. The optical system according to claim 1, characterized in that it has at least two optical surface components for varying the amplitude of at least one cubic term in combination with additional optical surface components for simultaneous variable correction of at least one, other optical aberration.

8. The optical system according to claim 1, characterized in that the movement is a parallel shift of at least one optical element relative to at least one other optical element.

9. The optical system according to claim 1 characterized in that the movement is a rotation of at least one optical element relative to at least one other optical element.

10. The optical system according to claim 1 characterized in that the optical system is adapted to provide correction of variable defocus aberration in combination with correction of variable spherical aberration for machine vision.

11. The optical system according to claim 1 characterized in that the optical system is adapted to provide correction of variable defocus aberration in combination with correction of variable spherical aberration for human vision.

12. The optical system according to claim 1 characterized in that the optical system is adapted to provide correction of at least two variable aberrations for solar concentrators.

13. The optical system according to claim 1 characterized in that the optical system is adapted to provide correction of at least two variable aberrations for image stabilization system.

14. The optical system according to claim 1 characterized in that the optical system is adapted to provide correction of at least two variable aberrations for multilayer CD/DVD pick-up system.
